(19) United States
(12) Patent Application Publication
(10) Pub. No.: US 2019/0112162 A1
(43) Pub. Date: Apr. 18, 2019

(54) COMB PLATE AND PEOPLE CONVEYOR

(71) Applicant: Otis Elevator Company, Farmington, CT (US)

(72) Inventor: Philipp Schedl, Vienna (AT)

(21) Appl. No.: 16/160,557

(22) Filed: Oct. 15, 2018

(30) Foreign Application Priority Data
Oct. 18, 2017 (EP) 17197053.6

(51) Int. Cl. B66B 29/06; B66B 23/14; B66B 21/04

(52) U.S. Cl. CPC B66B 29/06; B66B 21/04; B66B 23/14

(57) ABSTRACT

A comb plate (16) for a people conveyor (2) comprises a plurality of teeth (18, 20), wherein at least one of the teeth (20) includes a mechanical entrapment detection switch which is configured for detecting an incident of entrapment at said at least one tooth (20).

The invention relates to a comb plate for a people conveyor and to a people conveyor comprising such a comb plate.

People conveyors such as escalators and moving walkways usually comprise a conveyance band, which is configured for conveying passengers. The conveyance band extends and moves between two opposing landing zones. The conveyance band has a conveyance surface usually comprising cleats and grooves. A comb plate comprising a plurality of teeth extending into the grooves is provided at each of the landing zones.

Entrapment of foreign objects, in particular cloths or parts of a human body, or bent cleats at the comb plates may cause safety issues of people conveyors.

It therefore would be beneficial to provide a comb plate and a people conveyor which allow reliably detecting incidents of entrapment occurring at the comb plates.

According to an embodiment of the invention, a comb plate for a people conveyor having a conveyance band, which is configured for conveying passengers, comprises a plurality of teeth configured to be oriented towards the conveyance band of the people conveyor in a configuration where the comb plate is installed in the people conveyor. At least one of the teeth includes a mechanical entrapment detection switch which is configured for detecting incidents of entrapment at said at least one tooth.

Exemplary embodiments of the invention also include a people conveyor comprising a conveyance band, which is configured for conveying passengers, and at least one comb plate with a plurality of teeth oriented towards the conveyance band, wherein at least one of the teeth includes a mechanical entrapment detection switch which is configured for detecting an incident of entrapment at said at least one tooth. The conveyance band may comprise at least one tread surface with a plurality of grooves, and the teeth of the at least one comb plate may extend into said grooves.

A comb plate comprising at least one tooth including an entrapment detection switch allows a reliable detection of entrapment incidents at the comb plate. It further allows to stop any further operation of the people conveyor in case an entrapment is detected preventing passengers from getting injured or the people conveyor from being (further) damaged.

A number of optional features are set out in the following. These features may be realized in particular embodiments, alone or in combination with any of the other features.

The at least one tooth may comprise a stationary part, which is stationary with respect to the comb plate, and a movable element, which is movable with respect to the stationary part between a first position and a second position. The at least one tooth may further comprise at least one sensor, which is configured for detecting whether the movable element is positioned in its first or second position.

In such a configuration the combination of the stationary part, the movable element, and the at least one sensor provides a reliable entrapment detection switch allowing for a reliable detection of entrapment incidents at the comb plate without the need for additional assembly space.

The at least one sensor may comprise two electrical lines which are not electrically connected to each other when the movable element is positioned in the first position and which are electrically connected to each other when the movable element is positioned in the second position. Two electrical lines, which are selectively electrically connectable to each other depending on the position of the movable element, provide a simple but appropriate sensor for detection of the position of the movable element with respect to the stationary part.

The movable element in particular may be configured for electrically connecting the two electrical lines by itself. Alternatively, the movable element may be configured for activating an electrical switch for connecting the two electrical lines.

The at least one tooth may comprise at least one elastic element which is configured for urging the movable element towards one of the first and second positions in order to move the movable element in a well-defined initial position in case there is no entrapment. The at least one elastic element may be a spring, in particular a linearly acting spring such as a spiral spring, which is arranged between the stationary part and the movable element.

The movable element may be or may comprise a sleeve enclosing at least a portion of the stationary part. A sleeve enclosing at least a portion of the stationary part provides a mechanically strong and stable movable element, which does not need any additional assembly space. The sleeve may be configured to move in a sliding motion with respect to the stationary part. The sleeve in particular may be guided along the stationary part by means of appropriate guiding elements, such as grooves which are formed on one of the stationary part and the movable element and interact with corresponding protrusions formed on the other one of the stationary part and the movable element.

As an alternative to the sleeve, the movable element may comprise a pin which extends from the stationary part and which is movable with respect to the stationary part. A portion of the pin may extend inside the stationary part where it is protected from damage.

The movable element may be made partly of metal and/or plastic. Metal provides a very strong movable element; plastic provides a movable element having a low weight.

More than one of the teeth of the comb plate may include a mechanical entrapment detection switch as described herein, respectively, in order to reliably detect entrapment incidents over the whole width of the comb plate.

The at least one movable element may be movable in a direction which is parallel to the moving direction of the conveyance band when it passes the teeth of the comb plate. Thus, the movable element, when moved, moves parallel to the conveyance band when it passes the teeth.

In an alternative embodiment, the at least one movable element may be movable in a direction which is inclined, in particular oriented orthogonally, to the moving direction of the conveyance band when it passes the teeth of the comb plate. Thus, the movable element, when moved, does not move parallel to the conveyance band when it passes the teeth.

In the following exemplary embodiments of the invention are described with reference to the enclosed figures.

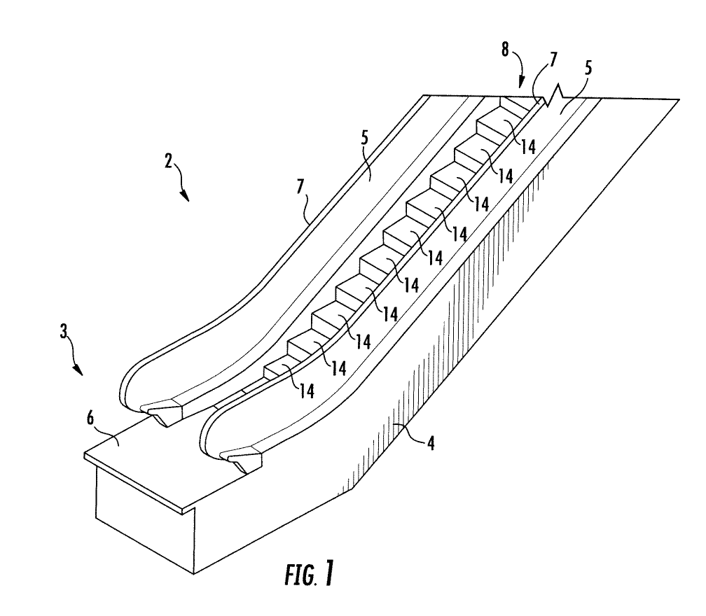

FIG. 1 shows a perspective view of a portion of a people conveyor according to an exemplary embodiment of the invention.

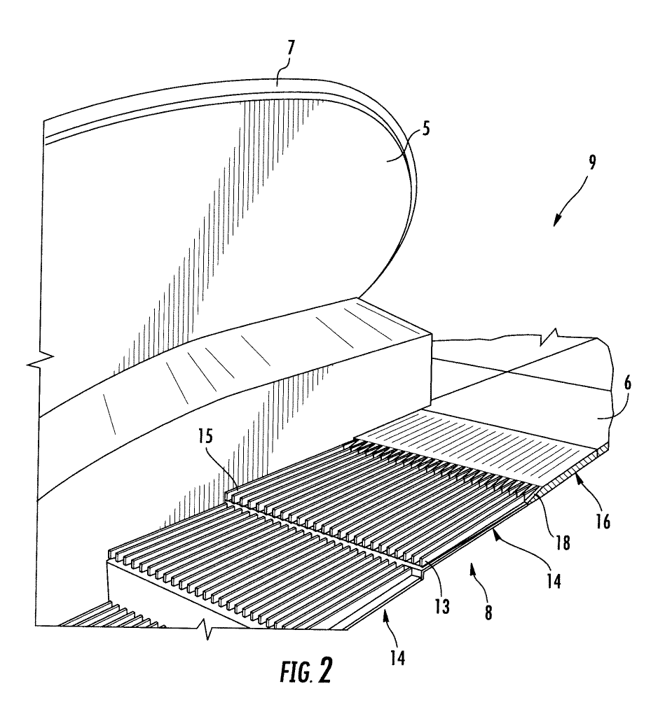

FIG. 2 shows an enlarged perspective view of an upper landing zone of the people conveyor.

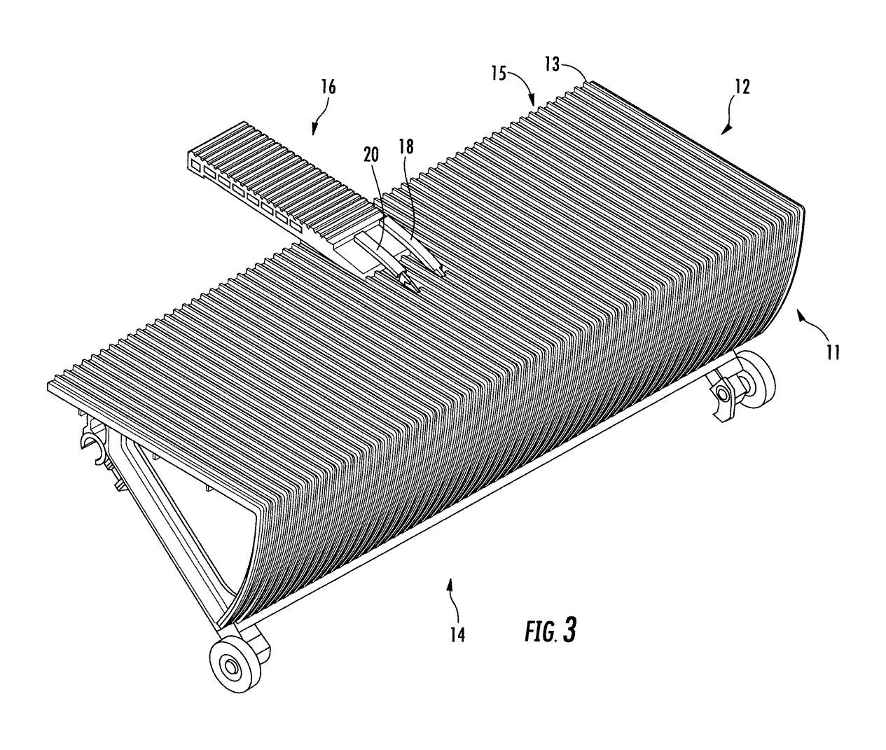

FIG. 3 shows a perspective view of a conveyance element and a section of a comb plate according to an exemplary embodiment of the invention.

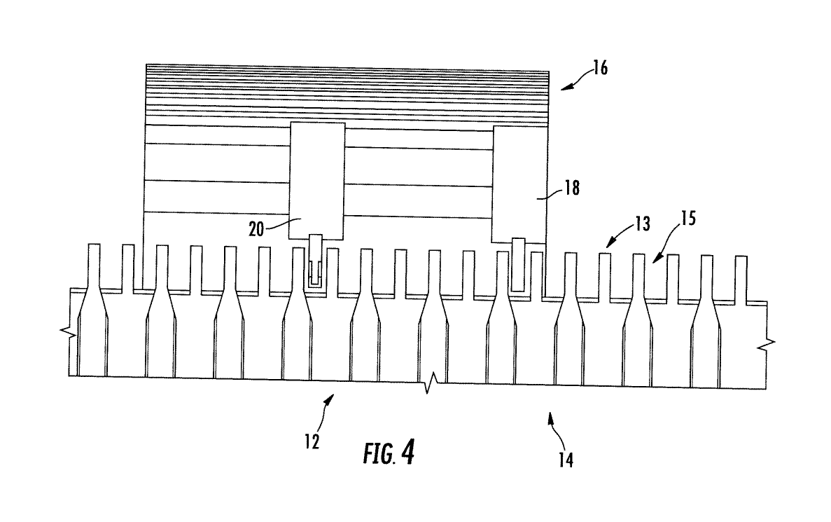

FIG. 4 shows an enlarged sectional view of the conveyance element and the section of the comb plate shown in FIG. 3.

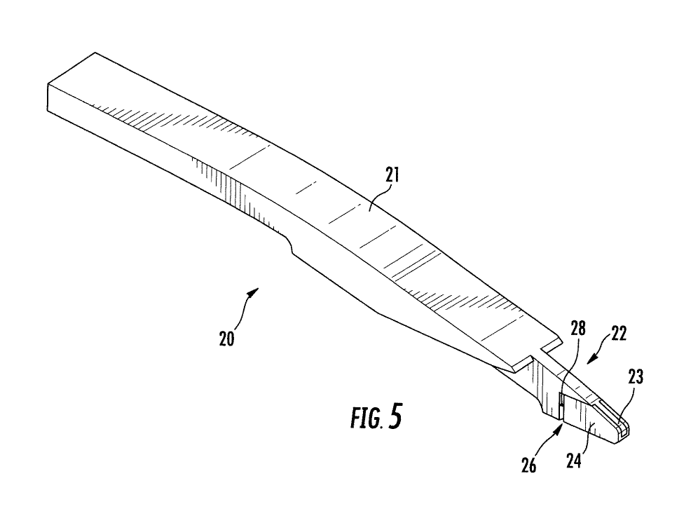

FIG. 5 shows a perspective view of a tooth comprising a mechanical entrapment detection switch according to an exemplary embodiment of the invention.

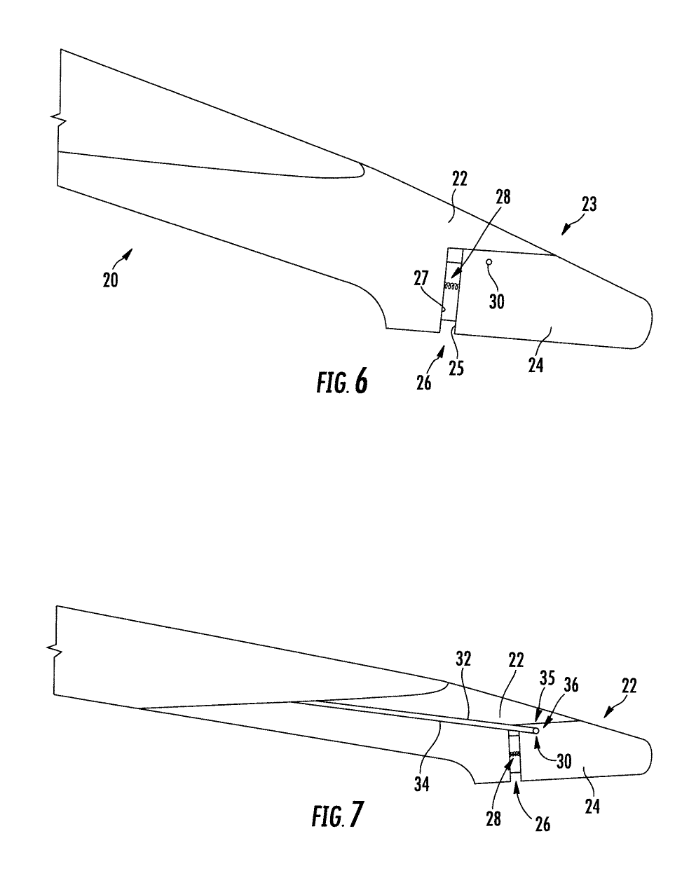

FIG. 6 shows a planar side view of the tooth shown in FIG. 5.

FIG. 7 shows a sectional view of the tooth shown in FIGS. 5 and 6.

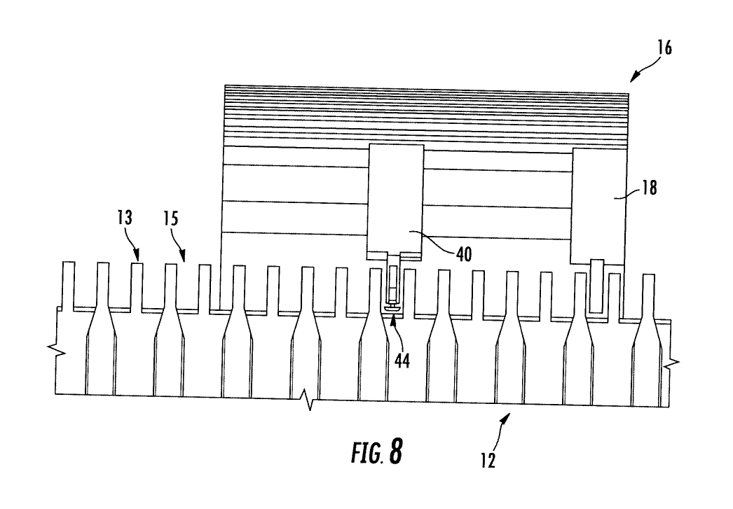

FIG. 8 shows an enlarged sectional view of a conveyance element and a section of a comb plate according to another exemplary embodiment of the invention.

FIG. 9 shows a perspective view of a tooth comprising a mechanical entrapment detection switch according to the other exemplary embodiment of the invention.

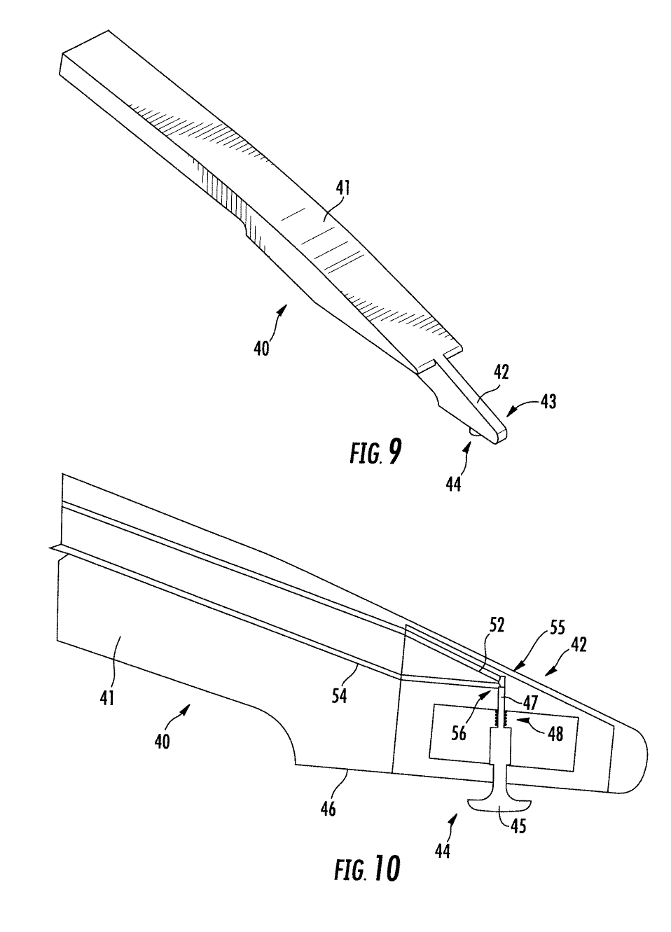

FIG. 10 shows a sectional view of the tooth shown in FIG. 9.

FIG. 1 shows a perspective view of a people conveyor 2 according to an exemplary embodiment of the invention.

The people conveyor 2 shown in FIG. 1 is an escalator comprising a plurality of steps 14. The people conveyor 2 comprises a truss 4 extending in a (longitudinal) conveyance direction between a lower landing zone 3 comprising a floor plate 6 and a corresponding upper landing zone 9 (see FIG. 2), which is not shown in FIG. 1.

The truss 4 supports a chain of conveyance elements (steps) 14 forming a conveyance band 8, which in the case of an escalator is a chain of steps 14, and two balustrades 5 extending parallel to the conveyance band 8. The balustrades 5 reside laterally at both sides of the conveyance band 8 respectively supporting a moving handrail 7.

Although the people conveyor 2 shown in FIG. 1 is an escalator comprising a plurality of steps 14, the skilled person will understand that the ideas and principles described in the following may be applied to horizontal and inclined moving walkways comprising pallets instead of steps 14 and to any other types of people conveyors 2 as well.

FIG. 2 shows an enlarged perspective view of the upper landing zone 9, which is not shown in FIG. 1.

FIG. 2 in particular illustrates that an upper surface of each of the conveyance elements 14 is provided with a plurality of alternating grooves 15 and cleats 13 extending in the conveyance direction.

A comb plate 16 is arranged next to floor plate 6 on the side of the floor plate 6 facing the conveyance band 8. The comb plate 16 comprises a plurality of teeth 18 extending parallel to the conveyance direction. The teeth 18 are in a staggered relation with the cleats 13 of the conveyance elements 14 and extend into the grooves 15 formed on the upper surfaces of the conveyance elements 14.

FIG. 3 shows a perspective view of a conveyance element, in this case a step, 14 of the people conveyor 2. The conveyance element 14 comprises a planar tread plate 12 and an arcuate riser portion 11 extending basically orthogonally from the tread plate 12.

FIG. 3 further shows a section of a comb plate 16 with two teeth 18, 20, which are attached to, or formed integrally with, the comb plate 16. The teeth 18, 20 extend along the conveyance direction. Tip portions of the teeth 18, 20 extend into the grooves 15 formed within or on the tread plate 12.

Although only a section of the comb plate 16 is shown in FIG. 3, the skilled person will understand that the comb plate 16 usually extends over the whole width of the conveyance element 14 and comprises a plurality of teeth 18, 20 extending into the grooves 15 formed on the tread plate 12 as it is shown in FIG. 2.

FIG. 4 shows an enlarged sectional view of the conveyance element 14 and the comb plate 16 shown in FIG. 3. FIG. 4 in particular illustrates the spatial relation between teeth 18, 20 and the grooves 15 of the tread plate 12.

In the exemplary embodiment shown in FIGS. 3 and 4, the tooth 18 shown on the right side of the respective figure is a conventional tooth 18, and the tooth 20 shown on the left side is provided with a mechanical entrapment detection switch according to an exemplary embodiment of the invention. Although only one tooth 20 comprising such an entrapment detection switch is shown in FIGS. 3 and 4, the skilled person will understand that the comb plate 16 may be provided with additional teeth 20 comprising such an entrapment detection switch, respectively.

FIGS. 5 to 7 show enlarged views of a tooth 20 comprising a mechanical entrapment detection switch according to a first embodiment of the invention.

FIG. 5 shows a perspective view of such a tooth 20 comprising a mechanical entrapment detection switch, FIG. 6 shows a planar side view and FIG. 7 shows a sectional view thereof.

The tooth 20 comprises a main body 21 and a stationary part 22. The main body 21 is stationarily mounted to, or formed integrally with, a main body of the comb plate 16 (cf. FIG. 4), and the stationary part 22 is stationarily mounted to, or formed integrally with, the main body 21.

The tooth 20 further comprises a movable element 24, which is movable with respect to the stationary part 22. The movable element 24 in particular is formed as sleeve 24 movably enclosing a tip portion 23 of the stationary part 22.

The movable element 24 in particular is movable along a longitudinal direction of the tooth 20 parallel to the moving direction of the conveyance elements 14 when they pass the teeth 18, 20 of the comb plate 16.

An elastic element 28, such as a spring, in particular a spiral spring is arranged between a rear end surface 25 of the movable element 24 and an opposing support surface 27 formed on the stationary part 22. The elastic element 28 urges the movable element 24 towards the end of the tooth 20 into a first position (initial position), as it is shown in FIGS. 5 to 7.

Two electrical lines 32, 34 (see FIG. 7) extend along the longitudinal direction of the tooth 20 into the tip portion 23. When the movable element 24 is positioned in the first position depicted in FIGS. 5 and 6, the two electrical lines 32, 34 are electrically connected by a connecting pin 30 extending transverse, in particular orthogonally, to the longitudinal direction through the stationary part 22 of the tooth 20.

In case of entrapment, i.e. when a foreign object, in particular parts clothing or a part of a human body, or a portion of a bent cleat 13 hits against the movable element 24, the movable element 24 is urged by the movement of the respective conveying element 14 to move against the elastic force of the elastic element 28 into a second position (to the left side in the orientation shown in FIGS. 5 to 7) narrowing the gap 26 between the stationary part 22 and the movable element 24.

Due to this movement of the movable element 24, the connecting pin 30 is moved from its connecting position shown in FIG. 7, in which it electrically connects the first and second electrical lines 32, 34 with each other, into a non-connecting position, in which the connecting pin 30 does not electrically connect the electrical lines 32, 34 anymore. Thus, the electrical lines 32, 34 in combination with the connecting pin 30 form an electrical switch 36 providing a sensor 35, which is configured for detecting whether the movable element 24 is positioned in its first or second position.

The described interruption of the electrical contact between the electrical lines 32, 34 may be detected by a detection circuit (not shown) which may issue an alarm signal and/or shut off the driving force applied to the conveyance elements 14 of the people conveyor 2 in order to prevent the entrapment from causing any (additional) harm or damage.

In an alternative configuration, which is not explicitly depicted in the figures, the electrical lines 32, 34 are not connected to each other when the moving element 24 is in its first position (no entrapment), and the electrical lines 32, 34 are electrically connected to each other when the movable element 24 is moved from its first position towards its second position in case of an entrapment incident.

An alternative embodiment of a tooth 40 comprising a mechanical entrapment detection switch is described in the following with reference to FIGS. 8 to 10.

FIG. 8 is similar to FIG. 4 and illustrates a tooth 40 comprising a mechanical entrapment detection switch extending into one of the grooves 15 formed on top of the tread plate 12.

FIG. 9 is similar to FIG. 5 and shows a perspective view of a tooth 40 comprising an entrapment switch according to a second embodiment of the invention. FIG. 10 shows a sectional view of the tooth 40.

The tooth 40 according to the second embodiment also comprises a stationary part 42, which is stationarily mounted to, or formed integrally with, a main body 41 of the tooth 40. The main body 41 is stationarily mounted to, or formed integrally with, the main body of the comb plate 16.

The tooth 40 also comprises a movable element 44, which in this embodiment is provided in the form of a movable pin 44. The movable pin 44 extends basically perpendicularly to the longitudinal direction, i.e. the moving direction of the conveyance elements 14 when passing the teeth 18, 20, 40 (cf. FIG. 2). The movable pin 44 in particular protrudes from a bottom surface 46 of the stationary part 42.

In the embodiment shown in FIGS. 8 to 10, a lower end of the movable pin 44 facing the tread plate 12 is formed as stamp 45 having a larger diameter than the rest of the movable pin 44. This increases the contact area between the movable pin 44 and a foreign object (not shown) in case of entrapment.

The movable pin 44 is elastically supported by an elastic element 48 such as a (spiral) spring, which is arranged within the stationary part 42 of the tooth 40. The movable pin 44 is movable basically orthogonally to the moving direction of the conveyance elements 14 when passing the tooth 40. The movable pin 44 in particular is movable between a first position, in which it extends from the lower surface 46 of the tooth 40, and a second position, in which it is pushed upwards into the stationary part 42 of the tooth 40.

As in the first embodiment, at least two electrical lines 52, 54 extend through the tooth 40. In the embodiment shown in FIG. 10, the two electrical lines 52, 54 are not electrically connected to each other when the movable pin 44 is positioned in its first position when there is no entrapment.

In case of entrapment, the movable pin 44 and in particular its lower stamp portion 45 contact a foreign element (not shown) or a bent cleat 13 of the tread plate 12. In consequence, the movable pin 44 is pushed upwards against the elastic force of the elastic element 48 into the stationary part 42 of the tooth 40.

As a result, a portion 47 of the movable pin 44 electrically connects the two electrical lines 52, 54. This closes an electric circuit, which is detected by a detection unit (not shown) to which the electrical lines 52, 54 are connected. The detection unit may issue an alarm signal and/or prevent any further movement of the conveyance elements 14. Thus, the electrical lines 52, 54 in combination with the movable pin 44 form an electrical switch 56 providing a sensor 55, which is configured for detecting whether the movable element 44 is positioned in its first or second position.

Alternatively, the electrical lines 52, 54 and the movable pin 44 may be configured such that the electrical lines 52, 54 are electrically connected with each other when the movable pin 44 is arranged in its first position (no entrapment), and that the electrical connection between the two electrical lines 52, 54 is interrupted when the movable pin 44 is moved from its first position towards a second position in case of entrapment. This interruption may be detected by the detection unit (not shown) to which the electrical lines 52, 54 are connected. The detection unit may issue an alarm signal and/or prevent any further movement of the conveyance elements 14.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention include all embodiments falling within the scope of the dependent claims.

### REFERENCES

2 people conveyor
3 lower landing zone
4 truss
5 balustrade
6 floor plate
7 handrail element
8 conveyance band
9 upper landing zone
11 riser portion
12 tread plate
13 cleat
14 conveyance element (step)
15 groove
16 comb plate
18 tooth
20 tooth
21 main body
22 stationary part
23 tip portion
24 movable element/sleeve
25 rear end surface
26 gap
27 support surface
28 elastic element/spring
30 connecting pin
32 electrical line
34 electrical line
35 sensor
36 electrical switch
40 tooth
41 main body
42 stationary part
43 tip portion
44 movable element/movable pin
45 stamp
46 bottom surface
47 portion of the movable pin
48 elastic element/spring
52 electrical line
54 electrical line
55 sensor
56 electrical switch

1. Comb plate (16) for a people conveyor (2), the comb plate (16) comprising a plurality of teeth (18, 20; 40), wherein at least one of the teeth (20; 40) includes a mechanical entrapment detection switch which is configured for detecting an incident of entrapment at said at least one tooth (20; 40).

2. Comb plate (16) according to claim 1, wherein the at least one of the teeth (20; 40) comprises a stationary part (22; 42), which is stationary with respect to the comb plate (16), and a movable element (24; 44), which is movable with respect to the stationary part (22; 42) between a first position and a second position.

3. Comb plate (16) according to claim 2, wherein the at least one tooth (20; 40) comprises at least one sensor (35; 55), which is configured for detecting whether the movable element (24; 44) is positioned in its first or second position.

4. Comb plate (16) according to claim 3, wherein the at least one sensor (35; 55) comprises two electrical lines (32, 34; 52, 54) which are electrically connected to each other when the movable element (24; 44) is positioned in the second position, and which are not electrically connected to each other, when the movable element (24; 44) is positioned in the first position.

5. Comb plate (16) according to claim 4, wherein the movable element (24; 44) itself is configured for electrically connecting the two electrical lines (32, 34; 52, 54), or wherein the movable element (24; 44) is configured for activating an electrical switch (36; 56) connecting the two electrical lines (32, 34; 52, 54).

6. Comb plate (16) according to claim 2, wherein the at least one tooth (20; 40) further comprises at least one elastic element (28; 48) which is configured for urging the movable element (24; 44) towards one of the first and second positions.

7. Comb plate (16) according to claim 2, wherein the movable element (24) comprises a sleeve (24) which is enclosing at least a portion of the stationary part (22).

8. Comb plate (16) according to claim 7, wherein the sleeve (24) is configured to move in a sliding motion with respect to the stationary part (22).

9. Comb plate (16) according to claim 2, wherein the movable element (44) comprises a movable pin (44) extending from the stationary part (42).

10. Comb plate (16) according to claim 2, wherein the movable element (24; 44) is made of metal and/or plastic.

11. Comb plate (16) according to claim 1, wherein a plurality of the teeth (20; 40) of the comb plate (16) include a mechanical entrapment detection switch, respectively.

12. People conveyor comprising at least one conveyance band (8), which is configured for conveying passengers, and at least one comb plate (16) according to claim 1.

13. People conveyor according to claim 12, wherein the conveyance band (8) comprises at least one tread surface (12) with a plurality of grooves (15), and wherein the teeth (18, 20; 40) of the at least one comb plate (16) extend into said grooves (15).

14. People conveyor according to claim 12, wherein the at least one movable element (24) is movable parallel to the moving direction of the conveyance band (8) when it passes the teeth (18, 20; 40) of the comb plate (16).

15. People conveyor according to claim 12, wherein the at least one movable element (44) is movable in a direction which is inclined, in particular oriented orthogonally, to the moving direction of the conveyance band (8) when passing the teeth (20; 40) of the comb plate (16).
